(19) United States
(12) Patent Application Publication
(10) Pub. No.: US 2025/0233637 A1
(43) Pub. Date: Jul. 17, 2025

(54) METHOD AND APPARATUS FOR GRANULARITY OPTIMIZATION OF TX AND/OR RX BEAM ANGLE(S)

(71) Applicant: Rakuten Symphony, Inc., Tokyo (JP)

(72) Inventors: Subramanya CHANDRASHEKAR, Karnataka (IN); Raghavendra Madanahally RAMAKRISHNA, Karnataka (IN)

(73) Assignee: Rakuten Symphony, Inc., Tokyo (JP)

(21) Appl. No.: 18/703,021

(22) PCT Filed: Feb. 20, 2024
(86) PCT No.: PCT/US2024/016478

§ 371 Date: Apr. 19, 2024

(30) Foreign Application Priority Data
Aug. 4, 2023 (IN) 202341052621
Dec. 1, 2023 (IN) 202341052621

(51) Int. Cl. H04B 7/06; H04B 17/391

(52) U.S. Cl. CPC H04B 7/06952; H04B 17/3913

(57) ABSTRACT

The present disclosure relates to techniques for predicting the Tx/Rx beam angle of the one or more dynamic beams, corresponding to the static broadcast beams, with optimized granularity. Particularly, the present disclosure receives, at a receiving entity, at least one of beam information and one or more control parameters. The beam information comprises Tx/Rx beam angles of one or more static broadcast beams. Subsequently, during the beam prediction, predicting using a pre-trained learning model, an optimized Tx/Rx beam angle for one or more dynamic beams corresponding to the one or more static broadcast beams, based on the received at least one of beam information, the one or more control parameters and an angle granularity information for effective communication. The angle granularity information defines variation in beam angle for predicting the optimized Tx/Rx beam angle.

### CROSS-REFERENCE TO RELATED APPLICATION(S)

This application claims the benefit of Indian Provisional Application No 202341052621, entitled “METHOD AND SYSTEM FOR GRANULARITY OPTIMIZATION OF TX AND/OR RX BEAM ANGLE(S)” and filed on Aug. 4, 2023, and of Indian Non-Provisional Application No 202341052621, entitled “METHOD AND SYSTEM FOR GRANULARITY OPTIMIZATION OF TX AND/OR RX BEAM ANGLE(S)” and filed on Dec. 1, 2023, which are expressly incorporated by reference herein in their entireties.

### TECHNICAL FIELD

The present disclosure relates to techniques for defining method and apparatus for granularity optimization of Transmit (Tx) and/or Receive (Rx) beam angle(s).

### BACKGROUND

The following description includes information that may be useful in understanding the present disclosure. It is not an admission that any of the information provided herein is prior art or relevant to the presently claimed disclosure, or that any publication specifically or implicitly referenced is prior art.

With the evolution of wireless communication systems under standards for 5G, base station and user equipment (UE) utilizes beamforming to compensate for path loss and short range. Beamforming is a signal processing technique that allows combining of signals received from multiple antennas for intended purpose such as Signal to Noise ratio (SINR) maximizing or for interference suppression. To increase the performance of beamforming process and for beam management, integration of Artificial Intelligence and Machine Learning (AI/ML) technologies may play a crucial role.

The AI/ML has the potential to revolutionize operation and service for 5G networks. By utilizing advanced algorithms, AI/ML optimizes network resource allocation, predict traffic patterns, and proactively manage network congestion. This leads to enhanced efficiency and improved user experiences on the 5G network. For these reasons, AI/ML is being put to use in field of beam management as well to enhance efficiency and improvement of overall performance of the wireless network.

In the existing scenario, beam prediction for a set of beams leads to different AI/ML generated output whose focus rely on predicting beam IDs. However, utilizing only beam ID prediction (without considering the granularity of the predicted beam) may not provide optimal results to serve the UE's user-plane session data.

The beams used for control plane signalling like Synchronous signal blocks (SSB)/Channel State Information reference signal (CSI-RS) beams are static in nature whereas the beams used to serve user plane data to a UE may be dynamically formed in accordance with UE's session and location. Since the SSB/CSI-RS beams are quantized to a set of fixed angles, both in azimuth and elevation domains by the BS and the beam ID prediction is based on these fixed angles, thus the granularity of the predicted beam is not appropriately considered. As a result, UE's user-plane data beam is considered as 1:1 mapped with the control plane beams. Therefore, beams are not optimally aligned with targeted user's exact location and the eventual beam that is used to serve is sub-optimal in nature.

In that case, even AI-ML model output of predicting beam ID provides granularity with limited range only. Further, these predicted beam IDs are associated with a predefined angle as well, which is not known to the UE and hence leads to inefficient beam management. In an alternative approach, AI-ML model output predicts the Tx and/or Rx Beam angles (where transmitted/broadcast beams' angles are considered same as that of predicted data beams), but that is also sub-optimal in nature as it fails to improve the UE tracking granularity over beam IDs and leads to inefficient results.

Thus, there is a need to deploy AI/ML algorithm in a more efficient and upgraded fashion to reap the best out of AI/ML domain and provide efficient beam management in wireless communication networks.

### SUMMARY

The present disclosure overcomes one or more shortcomings of the prior art and provides additional advantages. Embodiments and aspects of the disclosure described in detail herein are considered a part of the claimed disclosure.

In one non-limiting embodiment of the present disclosure, a method is disclosed. The method comprises receiving, at a receiving entity, at least one of beam information and one or more control parameters, wherein the beam information comprises Tx/Rx beam angles of one or more static beams (i.e., set B beams). The method further comprises predicting, using a pre-trained learning model, an optimized Tx/Rx beam angle for one or more dynamic beams (i.e., set A beams) corresponding to the one or more static beams, based on the received at least one of beam information, the one or more control parameters and an angle granularity information for effective communication. The angle granularity information defines variation in beam angle for predicting the optimized beam angle.

In another embodiment of the present disclosure, an apparatus is disclosed. The apparatus is configured to receive at least one of beam information and one or more control parameters. The beam information being received by the apparatus comprises Tx/Rx beam angles of one or more static broadcast beams (i.e., set B beams). The base station is further configured to predict, using a pre-trained learning model, an optimized Tx/Rx beam angle for one or more dynamic beams (i.e., set A beams) corresponding to the one or more static broadcast beams, based on the received at least one of beam information, the one or more control parameters and an angle granularity information for effective communication. The angle granularity information being received by the apparatus defines variation in beam angle for predicting the optimized Tx/Rx beam angle.

In yet another embodiment of the present disclosure, a non-transitory computer-readable storage medium storing executable instructions that, in response to execution, cause computer to receive at least one of beam information and one or more control parameters, wherein the beam information comprises beam angles of one or more static broadcast beams (i.e., set B beams). The non-transitory computer readable media further comprises one or more instructions to predict, using a pre-trained learning model, an optimized Tx/Rx beam angle for one or more dynamic beams (i.e., set A beams) corresponding to the one or more static broadcast beams, based on the received at least one of beam information, the one or more control parameters and an angle granularity information for effective communication. The angle granularity information defines the variation in beam angle for predicting the optimized Tx/Rx beam angle.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

The features, nature, and advantages of the present disclosure will become more apparent from the detailed description set forth below when taken in conjunction with the drawings in which like reference characters identify correspondingly throughout. Some embodiments of system and/or methods in accordance with embodiments of the present subject matter are now described, by way of example only, and with reference to the accompanying FIGS., in which:

FIG. 1 depicts an existing environment 100 illustrating two sets of beams (i.e., set A and set B beams) being transmitted from the BS, in accordance with the embodiments of the present disclosure;

FIG. 2 depicts an existing environment 200 illustrating a scenario where Set A beams are predicted corresponding to the beam angles of the set B beams;

FIG. 3 depicts an environment 300 where Tx and/or Rx beams angles of set A beams may be predicted with optimized granularity, in accordance with the embodiments of the present disclosure;

FIG. 4 depicts a flow diagram 400 illustrating the technique being disclosed by the present disclosure for predicting the Tx and/or Rx beams angles of dynamic (i.e., set A) beams corresponding to the static broadcast (i.e., Set B) beams with optimized granularity using a pre-trained learning model, in accordance with the embodiments of the present disclosure;

FIG. 5 depicts a flow diagram 500 predicting the Tx and/or Rx beams angles of dynamic (i.e., set A) beams corresponding to the static broadcast beams with optimized granularity using a pre-trained learning model, deployed at UE, in accordance with the embodiments of the present disclosure;

FIG. 6 depicts a flow diagram 600 predicting the Tx and/or Rx beams angles of dynamic (i.e., set A) beams corresponding to the static broadcast (i.e., set B) beams with optimized granularity using a pre-trained learning model, deployed at BS, in accordance with the embodiments of the present disclosure;

FIG. 7 depicts an apparatus to predict the Tx and/or Rx beams angles of dynamic (i.e., set A) beams corresponding to the static broadcast (i.e., set B) beams with optimized granularity using a pre-trained learning model, in accordance with the embodiments of the present disclosure;

FIG. 8 illustrates a flowchart 800 of an exemplary method for predicting the Tx and/or Rx beams angles of dynamic (i.e., set A) beams corresponding to the static broadcast (i.e., set B) beams with optimized granularity using a pre-trained learning model, in accordance with an embodiment of the present disclosure;

FIG. 9 illustrates an exemplary graph representing SNR (Signal to Noise Ratio) variation over time for a UE moving through different static beams (e.g., broadcast beams) in accordance with embodiments of the present disclosure;

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in a computer readable medium and executed by a computer or processor, whether or not such computer or processor is explicitly shown.

### DETAILED DESCRIPTION

The foregoing has broadly outlined the features and technical advantages of the present disclosure in order that the detailed description of the disclosure that follows may be better understood. It should be appreciated by those skilled in the art that the conception and specific embodiment disclosed may be readily utilized as a basis for modifying or designing other structures for carrying out the same purposes of the present disclosure.

The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

In the present disclosure, the term “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, “include”, “including”, or any other variations thereof, are intended to cover a non-exclusive inclusion, such that a device that comprises a list of components does not include only those components but may include other components not expressly listed or inherent to such setup or device. In other words, one or more elements in a system or apparatus proceeded by “comprises . . . a” does not, without more constraints, preclude the existence of other elements or additional elements in the system or apparatus.

The terms like “at least one” and “one or more” may be used interchangeably or in combination throughout the description.

The terms like “base station”, “eNB” and “gNB” may be used interchangeably or in combination throughout the description.

The terms like “static broadcast beams”, “static beams”, “control beams” and “set B beams” may be used interchangeably or in combination throughout the description.

The terms like “data beams”, “predicted beams”, “dynamic beams” and “set A beams” may be used interchangeably or in combination throughout the description.

Among various challenges faced in the process of accomplishing effective beam management, obtaining better granularity for the Tx and/or Rx beam angles is of great importance. In the current landscape of beam prediction in wireless communication, there exists a significant challenge in optimizing the alignment of beams for serving User Equipment (UE) data sessions. The AI/ML-generated output primarily focuses on predicting beam IDs, thereby this approach lacks consideration for the TX/RX angle and its granularity related information for predicting set B beams (e.g., data beams) in relation to the exact location of the UE. Beams used for control plane signaling (e.g., broadcast beams), such as Synchronous Signal Blocks (SSB) or Channel State Information Reference Signal (CSI-RS) beams, remain static, defined by fixed angles determined by the BS.

However, beams responsible for serving the UE can be dynamically formed and adjusted according to the UE's needs (based on position, location, and session). Due to the fixed angles of static beams, the dynamic beams (e.g., data beams) may also be considered to be received at these fixed angles (corresponding to static beams) only and thus the granularity of the predicted beam is insufficient. Consequently, the alignment between the beams used for control and data purposes is suboptimal, leading to overlap and inefficiencies. Even when AI-ML models predict Transmission (Tx) and/or Reception (Rx) beam angles, the granularity remains limited, failing to enhance UE tracking beyond beam IDs and/or fixed angles (as it dynamic beams are predicted based on 1:1 mapping with the static beams) resulting in inefficient beam management. This limitation in granularity and alignment between control/static and predicted/dynamic beams necessitate a more sophisticated approach to beam prediction for better optimization in serving UE's user-plane session data (e.g., data beams).

To overcome the challenges as described in the foregoing paragraph, the present disclosure aims to provide techniques for optimizing prediction of Tx and/or Rx beam angles, thus facilitating for improved granularity of beam angles. In particular, the present disclosure aims to provide a pre-trained learning model for predicting the optimized Tx/Rx beam angles for one or more dynamic beams corresponding to the one or more static beams. The present disclosure, in particular, describes a process where a receiving entity acquires at least one of beam information and control parameters, where the beam information encompasses the beam angles associated with received/static beams (i.e., set B beams). In an exemplary scenario, the static beams may be broadcast or control beams. Subsequently, using the pre-trained learning model, beam angle prediction process is facilitated at this receiving entity to determine an optimized Tx/Rx beam angle specifically tailored for the predicted/dynamic beams (e.g., data beams) linked to the aforementioned static beams. This prediction process relies not only on the received beam information and control parameters but also depends on angle granularity information that defines the variation permissible in beam angles for accurately predicting the Tx/Rx optimized beam angle. The angle granularity information serves as a crucial factor, outlining the degree of allowed variability in beam angles necessary for effective communication. In one non-limiting embodiment of the present disclosure, the pre-trained learning model may be deployed at the User Equipment (UE) and the receiving entity described above is hence UE. In another non-limiting embodiment, the pre-trained learning model may be deployed at the Base Station (BS) and hence the receiving entity described above is BS itself. In this way, the present disclosure provides technique for optimally predicting the beam angles for dynamic beams with enhanced granularity and achieves the goal of effective communication between the BS and UE.

FIG. 1 depicts an existing environment 100 illustrating two sets of beams being transmitted from the BS. In this, a BS 102 may be configured to transmit two different set of beams i.e., set B beams (e.g., broadcast beams) 104a, 104b, 104c and set A beams (e.g., data beams) 106a, 106b. In one scenario, the two sets of beams may be transmitted in the spatial domain. In an embodiment, the set B 104a, 104b, 104c beams may be different from the set A beams 106a, 106b (i.e., set A beams are not subset of set B beams). In another embodiment, the set A beams 106a, 106b may be a subset of set B beams 104a, 104b, 104c. In another scenario, the two sets of beams may be transmitted in the temporal domain. In an embodiment, the set B beams 104a, 104b, 104c and set A beams 106a, 106b may be different (i.e., set A beams are not subset of set B beams). In another embodiment, the set A beams 106a, 106b may be a subset of set B beams 104a, 104b, 104c (i.e., set A and set B beams are not same). In yet another embodiment, the set B beams 104a, 104b may be same as that of set A beams 106a, 106b.

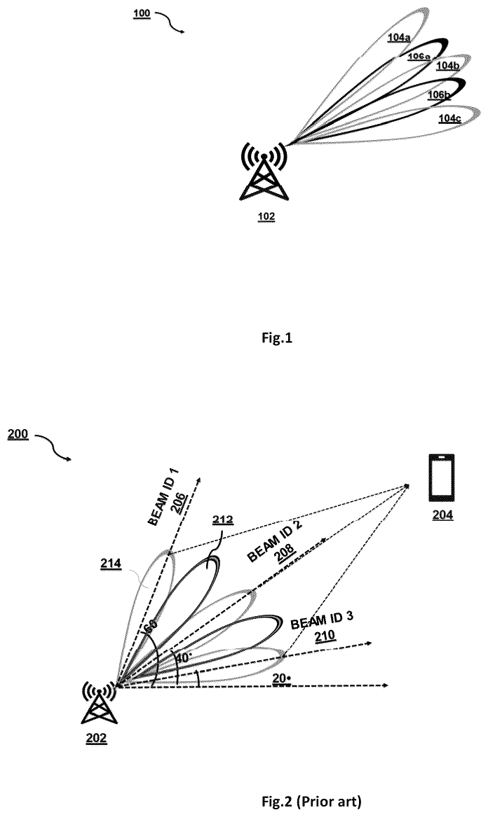

FIG. 2 depicts an existing environment 200 (i.e., as per the conventional technology) illustrating a scenario where set A beams are predicted corresponding to the beam angles of the set B beams. In particular, BS 202 may be configured to transmit set B beams 214 with corresponding beam IDs 206, 208, 210 to UE 204, for providing essential control information required for establishing effective communication. The learning model deployed at the receiving entity, UE 204 in this scenario, may be trained to predict the orientation (azimuth and elevation) of the set A beams 212 based on the received beam IDs 206, 208, 210 and the respective corresponding beam angles 60°, 40° and 20° of the set B/static beams 214. Thus, when the static beams 214 with beam IDs 206, 208 and 210 are received by the UE 204 then the learning model deployed at the UE may predict the set A beams 212 at the same beam angle as that of the received set B beams 214 thus implementing 1:1 mapping of the set A beams 212 with the set B beams 214. This scenario holds good if the dynamic beams are actually present on the same angles as that of static beams. However, the issue arises when the set A beams 212 are not 1:1 mapped to the corresponding set B beams 214 i.e., when the set A/predicted beams 212 may lie between the beam ID1 206 and beam ID2 208 or beamID2 208 and beamID3 210, for instance.

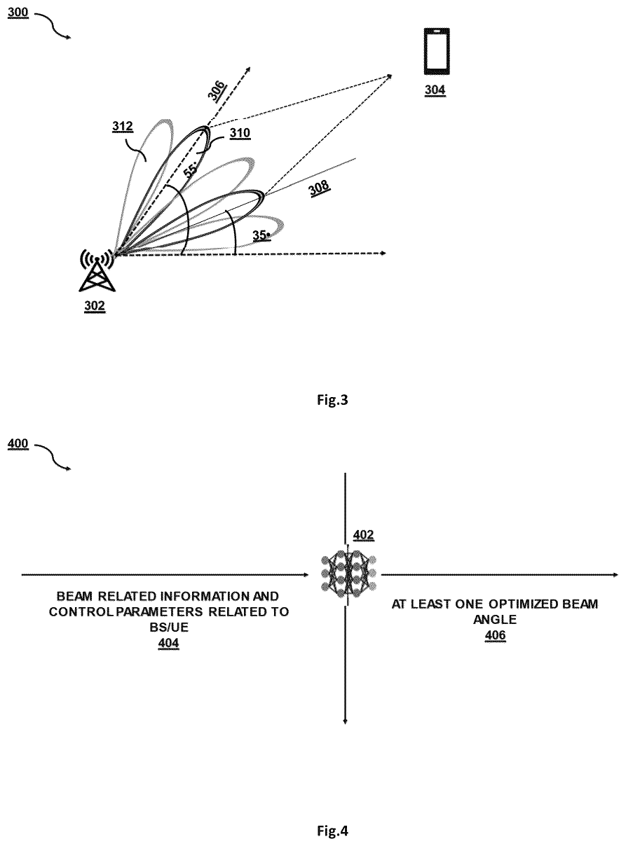

Now as already explained, in the foregoing paragraph, that the set B beams (e.g., broadcast beams) 214 are fixed for all the UEs in a given cell and are quantized to a set of fixed angles, in this case 60°, 40° and 20° respectively, both in azimuth and elevation domains by the BS 202. However, the set A beams 212 are dynamically formed and hence are subject to change in orientations as and when deemed necessary based on number of parameters like channel state information, location of UE, etc. In these scenarios, the UE 204 may not optimally determine the appropriate beam angle at which predicted beams should be received and/or transmitted because the existing AI/ML model is trained to predict the Tx and/or beam angles of the set A beams 212 corresponding the set B beams 214 (in 1:1 mapping) as shown in FIG. 2. The present disclosure aims to overcome the challenges associated with the existing scenario and provides a technique for optimally predicting the Tx/Rx beam angles for dynamic i.e., set A beams with enhanced granularity so as to achieve the goal of effective communication. Same is explained in detail the upcoming paragraph in conjunction with FIG. 3 of the present disclosure.

FIG. 3 depicts an environment 300 (i.e., in accordance with the present disclosure) where Tx and/or Rx beams angles of set A beams may be predicted with optimized granularity. Precisely, the learning model may be trained in such a way that it predicts the Tx and/or Rx beams angles of set A beams 310 corresponding to the set B beams 312 with optimized granularity. In one non-limiting embodiment, if the pre-trained learning model is deployed at the UE 304 for predicting the Tx and/or Rx beams angles of set A beams 310 corresponding to the set B beams 312 with optimized granularity, then the BS 302 may transmit the set B beams 312 with beam IDs 1, 2 and 3 along with the information about their corresponding beam angles 60°, 40° and 20° (for instance), in reference to FIG. 2 of the present disclosure. As evident in FIG. 2, AI-ML model output of predicting beam ID may only give an angle granularity in accuracy of 20°, but nothing in between and hence, it may be established that optimum angle granularity is not being achieved by the existing methods of beam management using AI/ML model leading to poor downlink and uplink performance KPIs.

Coming back to FIG. 3, as shown in FIG. 3 instead of predicting the set A beams (e.g., data beams) with same beam angles as that of the set B beams (e.g., broadcast beams), the learning model at the UE 304 may be trained to retrieve the beam information and related parameters from the base station 302. Considering the earlier exemplary scenario (as presented in FIG. 2), the set B beams 104a, 104b and 104c are considered to be fixed at specific angles of 60° and 40° respectively and let the specificity with which angle granularity of Tx and/or Rx beams is configured by base station be 5°. The granularity information is provided by the base station e.g., gNB to the UE. In an exemplary embodiment, the angle granularity information may be configured by a network operator. In another embodiment, the angle granularity information may not be network specific but may be configured by the vendor or service provider. Now, when the AI-ML model is deployed at the UE and the angle granularity information, beam information and one or more control parameters are provided by the base station to the UE, the UE may predict the set A beams which may not be 1:1 mapped with the set B beams. For example, the angle granularity information provided by the base station is 5° then instead of predicting the set A beams corresponding to 60° and 40° only, the UE may consider 5 different angles such as 60°, 55°, 50°, 45°, 40° for predicting the set A beams. As specified in FIG. 3, the optimized Tx/Rx beam angle considered to be used for communication with the base station may be 55° instead of 60°. In this way, the output prediction of beam management using AI-ML based model results in Tx and/or Rx beam angles for dynamic beams which may or may not be 1:1 mapped with the angles of transmitted/static beams and thus, achieves better granularity.

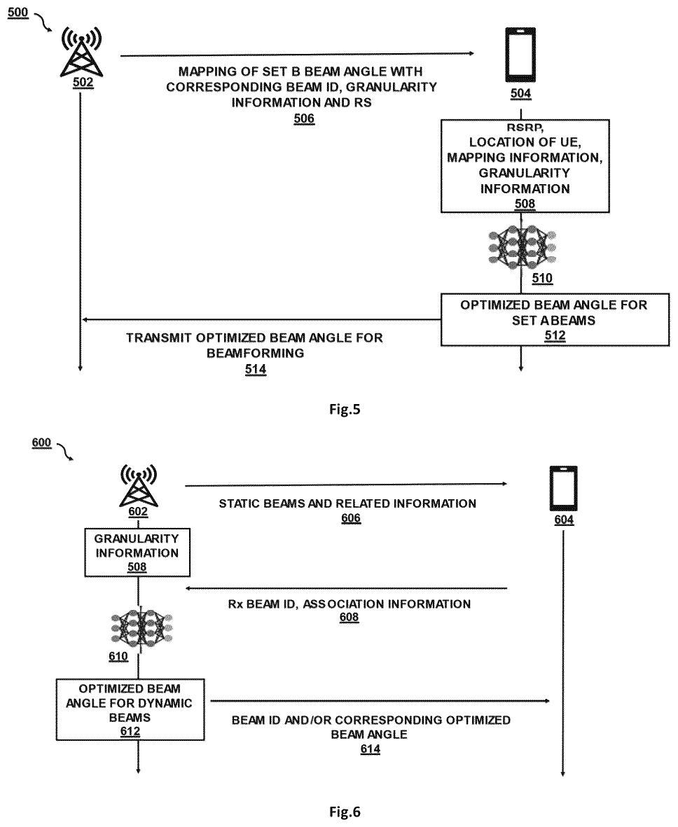

In another non-limiting embodiment, the learning model may be deployed at the BS 302, if that be the case, the BS 302 may be configured to instruct the UE 304 to transmit beam information and control parameters to help BS 302 in predicting the optimized Tx and/or Rx beams angle of set A beams 310 corresponding to the set B beams 312 with optimized granularity. The detailed process has been explained in the forthcoming paragraphs in conjunction with FIGS. 4-6 of the present disclosure.

FIG. 4 depicts a flow diagram 400 illustrating the technique being disclosed by the present disclosure for predicting the Tx and/or Rx beams angles of set A beams (e.g., data beams) corresponding to the set B beams (e.g., broadcast beams) with optimized granularity using a pre-trained learning model. As shown in FIG. 4, the learning model 402 may be configured to retrieve 404, from the receiving entity, at least one of the beam information and the control parameters shared by the transmitting entity along with the broadcast beams. In an exemplary embodiment, the receiving entity is a UE whereas the transmitting entity is BS. In another embodiment, the receiving entity is a BS whereas the transmitting entity is UE. After retrieving the requisite information, the pre-trained learning model 402 may be configured to predict 406 an optimized Tx/Rx beam angle for one or more dynamic beams corresponding to the one or more static beams. This prediction of the optimized Tx/Rx beam angle for one or more dynamic beams may be based upon the retrieved at least one of the beam information and the related control parameters along with the granularity information.

Those skilled in the rat will appreciate that the granularity information may be defined as the variation in beam angle i.e., the degree of variability at which the receiving entity may be facilitated to look for predicted beams (e.g., data beams) and thus enable more granular and precise orientation (both azimuth and elevation) of the predicted beams with respect to the corresponding transmitted/static beams (e.g., broadcast beams). In this way, AI-ML model facilitates efficient beam management and enables robust communication between BS and UE over the wireless network. In one non-limiting embodiment, the pre-trained learning model 402 may be deployed at the UE, facilitating the UE to determine the beam angles for one or more dynamic/set A beams corresponding to the static/set B beams as explained in detail in the forthcoming paragraphs in conjunction with FIG. 5. In another non-limiting embodiment, the pre-trained learning model 402 may be deployed at the BS, facilitating the BS to determine the beam angles for one or more dynamic beams/set A beams corresponding to the static/set B beams as explained in detail in the forthcoming paragraphs in conjunction with FIG. 6.

FIG. 5 depicts a flow diagram 500 predicting the Tx and/or Rx beams angles of dynamic beams (e.g., data beams) corresponding to the static (e.g., broadcast) beams with optimized granularity using a pre-trained learning model 510, deployed at UE 504. As shown in FIG. 5, the BS 502 may be configured to transmit the beams (i.e., set B) to the UE 504 along with the requisite beam information 506. In one non-limiting embodiment, the beam information 506 may comprise at least one of mapping of the Tx/Rx beam angles of the transmitted beams (Set B) with corresponding one or more beam IDs, angle granularity information and the Reference signal (RS). In a non-limiting embodiment, the angle granularity information from the BS 502 may be transmitted in a Radio Resource Control (RRC) message to the UE 504.

Moving on, once the broadcast beams are received by the UE 504 along with reference signals as beam information, the UE 504 may be configured to predict RSRP (Reference signal received power) from the RS. The UE 504 may be further configured to determine its own location and then feed both the parameters i.e., (RSRP and location of the UE) 508 along with the received beam information (i.e., mapping of the beam angles of the transmitted beams with corresponding beam IDs) to the pre-trained learning model 510. The pre-trained learning model 510 may in turn be configured to analyze the retrieved information and/or parameters and thereby predict 512 the Tx/Rx optimized beam angle for one or more predicted/dynamic beams corresponding to the static beams. In one non-limiting embodiment, the pre-trained learning model 510 may be configured to predict the Tx/Rx beam angle for the one or more data beams with optimized granularity by taking into account at least one of the location of the UE 504, RSRP, angle granularity information and the angle of the received broadcast beams corresponding to their respective beam IDs and predict the best beam angle, in view of the given granularity information, for the predicted beams.

In an exemplary embodiment, the AI-ML model may utilize UE's location, beam ID mapping information, reference signal and granularity information. Based on these, the model determines the L1-RSRP (Layer 1 Reference Signal Received Power) report corresponding to each angle (as per granularity information) i.e., 60°, 55°, 50°, 45°, 40°. The RSRP reports describe the power level of the reference signals received at the physical layer of the UE. The angle at which higher RSRP value (closer to 0 dBm) is achieved is considered as optimized beam angle. In particular, the optimized angle is the angle at which stronger signal strength is received i.e., indicates good signal quality and a high probability of a successful communication link between the UE and the Base Station. Once the Tx/Rx optimized angle is determined, the Tx/Rx optimized angle information and/or the beam ID corresponding to the Tx/Rx optimized angle is transmitted from the UE 504 to the BS 502.

In one non-limiting embodiment, the granularity information may be configured at the BS 502 by the vendor or network operator. In a non-limiting embodiment, the beam information (mapping between the beam angle and corresponding beam ID) may be transmitted from the BS 502 to the UE 504 over Radio Resource Control (RRC) signalling. For example, the beam information to UE may be transmitted by the serving gNB-DU (Distributed Unit) by initiating a F1: UE Context Modification procedure. Further, the gNB-CU sends this mapping information to the UE over RRC signalling. In another embodiment, the beam information to UE may be broadcasted over SIB1 (System Information Block) by the BS 502 to inform the mapping between beam IDs and their corresponding angles to the UE. This information is essential for UE and should be available to all UEs employing beam management by AI-ML model. A person skilled in the art would appreciate that the discussed process may results in Tx and/or Rx beam angles for dynamic beams which may not necessarily be 1:1 mapped to the control plane beams and thus, achieves better granularity and enhances the overall efficiency of the entire wireless network.

FIG. 6 depicts a flow diagram 600 predicting the Tx and/or Rx beams angles of predicted/dynamic beams (e.g., data beams) corresponding to the static beams (e.g., broadcast beams) with optimized granularity using a pre-trained learning model 612, deployed at BS 602. According to FIG. 6, the BS 602 may be configured to transmit the static beams to the UE 604 along with the requisite beam information 606. In one non-limiting embodiment, the beam information 606 may comprise beam related information such as RS along with the static beams. The UE 604, in turn, may be configured to analyze the static beams along with the corresponding beam information. The UE 604 may be then configured to transmit 608 at least one of beam ID and association information to the BS 602. In one non-limiting embodiment, the beam ID corresponding to the received static beams (Rx beam ID) may be provided by the UE 604 along with the RSRP feedback.

In another non-limiting embodiment, the association information may comprise information related to total number of antenna panels at the UE, total number of received beams and beams per panel, number of received beams in Azimuth and elevation per panel, Panel used for received beam, Beamwidth of the beams per panel. Upon receiving the information 608, the pre-trained learning model 610 deployed at the base station may analyse the received information along with the angle granularity information 508 to predict the optimized Tx/Rx beam angle for one or more dynamic beams 612 corresponding to the transmitted static beams. In one non-limiting embodiment, the angle granularity information 508 may be configured at the BS 602 by the vendor or network operator. After predicting the optimized Tx/Rx beam angle for one or more dynamic beams at step 612, the pre-trained learning model 610 may be further configured to determine the beam ID and corresponding optimized Tx/Rx beam angle for one or more dynamic beams. The BS 602 then transmits the optimized Tx/Rx beam angle for one or more dynamic beams and the corresponding determined beam ID in step 614 to the UE 604. In this way, BS 602 may serve the UE 604 with optimized beamforming direction, thus providing higher data rates, and increased spectral efficiency with reduced interference, enhancing the overall productivity and efficiency of the wireless network.

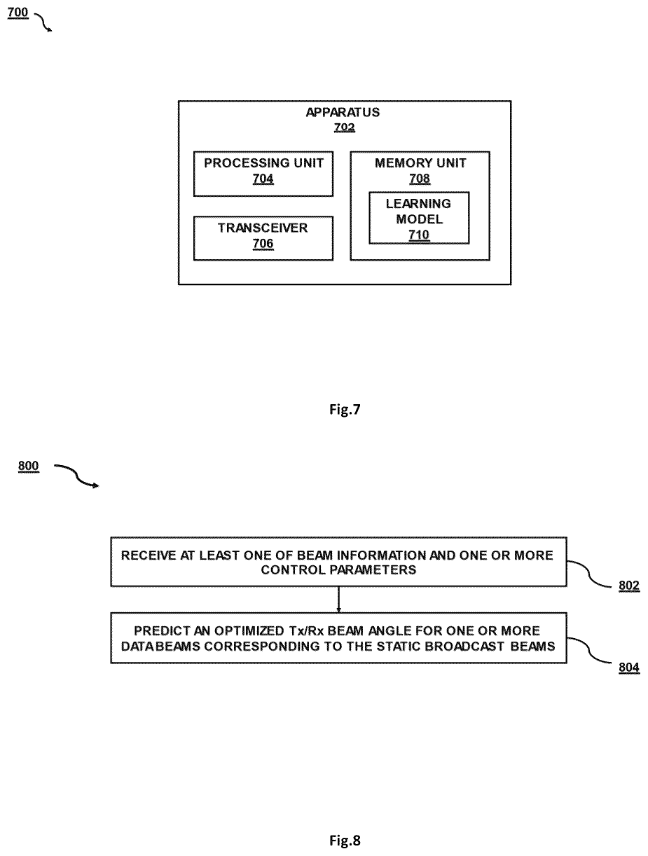

FIG. 7 depicts an apparatus to predict the Tx and/or Rx beams angles of set A beams corresponding to the set B beams with optimized angle granularity using a pre-trained learning model. In one non-limiting embodiment, the apparatus may be a UE when the pre-trained learning model to predict the optimized angle granularity may be deployed at the UE. In case the apparatus is UE, the apparatus 702 comprises a processing unit 704, a transceiver 706, a memory unit 718 and a pre-trained learning model 710. The transceiver 706 may be configured to receive and transmit beams and other related information from and to the BS. In particular, the transceiver 706 receives the static beams and the related information along with the control parameters such as the received information about the mapping of the beam angles of the transmitted beams with corresponding one or more beam IDs, the angle granularity information and RS as the beam information. The transceiver 706 may be further configured to send this received information to the processing unit 704 of the UE. The processing unit 704 in conjunction with the memory unit 708 may be configured to determine the RSRP report of the received beams with the help of the Reference signal (RS). The memory unit 708, in turn, may be configured to store the received as well as the processed information. Thereafter, the requisite information may be retrieved by the pre-trained learning model 710 from the memory unit 708. With help of RSRP reports, mapping information and the location of the UE, the learning model 710 predicts the optimized Tx/Rx beam angle of predicted/set A beams. The predicted/optimized Tx/Rx beam angles may then be transmitted to the BS by the transceiver 706 of the apparatus 702.

In another non-limiting embodiment, the apparatus may be a BS when the pre-trained learning model to predict the optimized granularity for the data/dynamic beams may be deployed at the BS. In this, apparatus 702 comprises a processing unit 704, a transceiver 706, a memory unit 718 and a learning model 710. The transceiver 706 may be configured to receive and transmit beams and other related information from and to the UE. In particular, apparatus (BS in this scenario) 702 comprises a processing unit 704, a transceiver 706, a memory unit 708 and a learning model 710. As the static/set B beams along with related information may be transmitted from the BS to the UE via transceiver 706 in earlier scenario (when model was deployed at UE). However, in this scenario (as apparatus is BS), the transceiver 706 may be configured to receive the beam IDs and the association information from the UE in current scenario (when model was deployed at BS). The processing unit 704 in conjunction with the memory unit 708 may be further configured to process the granularity information stored in the memory unit 708. The pre-trained learning model 710 may be then configured to retrieve the requisite information (such as Rx beam ID and association information) from the memory unit 708 and analyze the same to predict the optimized beam angle for the one or more dynamic beams corresponding to the static beams. The pre-trained learning model 710 may be further configured to determine the beam IDs corresponding to the predicted beam angle for the dynamic/set A beams. The transceiver 706 may then be configured to transmit the predicted optimized beam angles with their corresponding beam IDs to the UE.

FIG. 8 illustrates a flowchart 800 of an exemplary method for predicting the Tx and/or Rx beams angles of data beams corresponding to the broadcast beams with optimized granularity using a pre-trained learning model, in accordance with an embodiment of the present disclosure. The method 800 may also be described in the general context of computer executable instructions. Generally, computer executable instructions may include routines, programs, objects, components, data structures, procedures, modules, and functions, which perform specific functions or implement specific abstract data types.

The order in which the method 800 is described is not intended to be construed as a limitation, and any number of the described method blocks may be combined in any order to implement the method. Additionally, individual blocks may be deleted from the methods without departing from the spirit and scope of the subject matter described.

At step 802, the method 800 may include receiving, at a receiving entity, at least one of beam information and one or more control parameters. In one non-limiting embodiment, the beam information comprises Tx/Rx beam angles of one or more static broadcast beams. In one non-limiting embodiment, the transceiver may be configured to receive at least one of the beam information and one or more control parameters.

At step 802, the method 800 may include predicting an optimized Tx/Rx beam angle for one or more dynamic beams corresponding to the one or more static beams, based on the received at least one of beam information, the one or more control parameters and an angle granularity information for effective communication. In one non-limiting embodiment, the angle granularity information may be defined as the variation in beam angle for predicting the optimized Tx/Rx beam angle.

In an exemplary embodiment, if the method is performed at a User Equipment (UE), the UE receives at least one of mapping of the Tx/Rx beam angles of the static beams (i.e. broadcast beams) with corresponding one or more beam IDs, the angle granularity information, and a reference signal as the beam information from a Base station. The received reference signal is used for predicting Reference signal received power (RSRP) and with the help of RSRP reports. Further, the pre-trained model deployed at UE, uses current location of the UE in a cell and predicted RSRP reports as the one or more control parameters for predicting the optimized beam angle as stated in step 802. Further, the mapping of the Tx/Rx beam angles of the one or more static beams with the corresponding one or more beam ID is received over Radio Resource Control (RRC) signaling or over System Information Block type1. Furthermore, the pre-trained learning model initially receives the angle granularity information from the base station in a Radio Resource Control (RRC) message.

In an exemplary embodiment, if the method is performed at a Base station (BS), the BS receives at least one of Beam ID from a UE as beam information and association information as the one or more control parameters, wherein the association information comprises at least one of: total number of antenna panels at the UE, total number of received beams and beams per panel, number of received beams in Azimuth and elevation per panel, Panel used for received beam, Beamwidth of the beams per panel. Based on the above information, the pre-trained model deployed at BS predicts the optimized Tx/Rx beam angle as stated in step 802. Thereafter, the BS determines a beam ID corresponding to the optimized Tx/Rx beam angle and transmits at least one of the optimized Tx/Rx beam angles and the beam ID to the UE for beamforming of one or more dynamic beams (e.g., data beams).

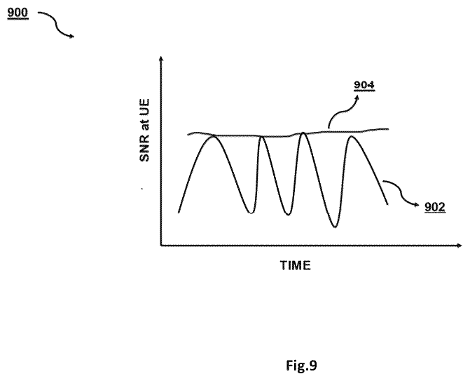

FIG. 9 illustrates an exemplary graph representing SNR variation over time for a moving UE through different static beams (e.g., broadcast or control beams).

Elaborating on this, SNR is the relative strength of the useful signal (i.e., the desired information) compared to the background noise or interference present in the communication channel. As beam management relies on focusing the signals in specific directions, creating focused beams that improve signal quality for UE within the beam's coverage area but when the UE moves through different static beams, the received signal power can change significantly, leading to significant variations in SNR. Interference from other UEs, handover and beam switching are some of the other important factors contributing to variations in SNR when UE shifts from one static (control) beam to another beam. These SNR variations are determined on the basis of the feedback provided by the UE to base station.

As already explained in background section, existing techniques of beam prediction via AI-ML model have various shortcomings when overall performance of the wireless network is concerned. So, when it comes to SNR variations, the existing methods do not hold up to the efficiency requirements. The interference involved in AI-ML model-based beam ID prediction due to lack of UE's knowledge of beam-ID to beam-angle association and 1:1 mapping of static and dynamic beams results in interference and leads to SNR variations. Thus, when UE moves across different static beams (e.g., broadcast or control beams) then SNR at UE also changes overtime as depicted by wave 902 of FIG. 9 hampering the overall performance of the wireless network.

In contrast, when AI-ML based model is deployed for beam management, it helps in optimizing beamforming and improving SNR, leading to reduced variations in SNR even when the UE moves through different static beams. As output prediction of beam management use case results in Tx and/or Rx beam angles which are not necessarily 1:1 mapped to the static beams and provides better granularity as per UE's location and other parameters thus, the user may be served with lesser SNR variations at UE. In Particular, after deploying the optimized granularity of Tx and/or Rx beam angle(s) by using AI-ML based model for beam management, SNR at UE remains fairly constant as illustrated by wave 904 in FIG. 9 and hence no significant SNR variations are tracked thus, the present disclosure contributes to the overall efficiency of the wireless network.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed.

Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., are non-transitory. Examples include random access memory (RAM), read-only memory (ROM), volatile memory, non-volatile memory, hard drives, CD ROMs, DVDs, flash drives, disks, and any other known physical storage media.

Suitable processors include, by way of example, a general-purpose processor, a special purpose processor, a conventional processor, a digital signal processor (DSP), a graphic processing unit (GPU), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

### Advantages of the Embodiment of the Present Disclosure are Illustrated Herein

Present disclosure provides techniques for predicting the optimized granularity of the Tx and/or Rx beam angles of one or more dynamic beams (e.g., data beams) corresponding to the static beams (e.g., broadcast beams, control beams).

Present disclosure provides techniques for establishing effective and robust communication between the transmitting and receiving entities (e.g., base station and UE) thus facilitating efficient beam management.

Present disclosure provides constant Signal to Noise Ratio (SNR) at UE thus, improving the overall efficiency of the wireless network.

Implementation examples are described in the following clauses:

Clause 1: A method comprising: receiving, at a receiving entity, at least one of beam information and one or more control parameters, wherein the beam information comprises Tx/Rx beam angles of one or more static beams; and predicting, using a pre-trained learning model, an optimized Tx/Rx beam angle for one or more dynamic beams corresponding to the one or more static broadcast beams, based on the received at least one of beam information, the one or more control parameters and an angle granularity information for effective communication, wherein the angle granularity information defines variation in beam angle for predicting the optimized Tx/Rx beam angle.

Clause 2: The method of clause 1, wherein if the pre-trained learning model for predicting the optimized Tx/Rx beam angle for the dynamic beams is deployed at a User Equipment (UE), the method further comprises: receiving, from a Base station, at least one of mapping of the Tx/Rx beam angles of the static broadcast beams with corresponding one or more beam IDs, the angle granularity information, and a reference signal as the beam information, wherein the received reference signal is used for predicting Reference signal received power (RSRP) for the UE; and providing, to the pre-trained learning model, current location of the UE in a cell and predicted RSRP as the one or more control parameters.

Clause 3: The method of clause 2, wherein the mapping of the Tx/Rx beam angles of the one or more static broadcast beams with the corresponding one or more beam ID is received over Radio Resource Control (RRC) signaling or over System Information Block type1.

Clause 4: The method of clause 2, wherein the pre-trained learning model initially receives the angle granularity information from the base station in a Radio Resource Control (RRC) message.

Clause 5: The method of clause 1, wherein if the pre-trained learning model for predicting the optimized Tx/Rx beam angle for the dynamic beams is deployed at the base station, the method further comprises: receiving, from a UE, at least one of Beam ID as beam information and association information as the one or more control parameters, wherein the association information comprises at least one of total number of antenna panels at the UE, total number of received beams and beams per panel, number of received beams in Azimuth and elevation per panel, Panel used for received beam, Beamwidth of the beams per panel.

Clause 6: The method of clause 5, wherein if the pre-trained learning model for predicting the optimized Tx/Rx beam angle for the dynamic beams is deployed at the base station, the method further comprises: determining a beam ID corresponding to the optimized Tx/Rx beam angle; and transmitting, from the base station, at least one of: the optimized Tx/Rx beam angle and the beam ID to the UE for beamforming of one or more dynamic beams.

Clause 7: An apparatus configured to: receive at least one of beam information and one or more control parameters, wherein the beam information comprises Tx/Rx beam angles of one or more static broadcast beams; and predict, using a pre-trained learning model, an optimized Tx/Rx beam angle for one or more dynamic beams corresponding to the one or more static broadcast beams, based on the received at least one of beam information, the one or more control parameters and an angle granularity information for effective communication, wherein the angle granularity information defines variation in beam angle for predicting the optimized Tx/Rx beam angle.

Clause 8: The apparatus of clause 7, wherein if the apparatus is a User Equipment (UE), the apparatus is configured to: receive at least one of mapping of the Tx/Rx beam angles of the static broadcast beams with corresponding one or more beam IDs, the angle granularity information, and a reference signal as the beam information, wherein the received reference signal is used for predicting Reference signal received power (RSRP) for the UE; and provide current location of the UE in a cell and the predicted RSRP as the one or more control parameters.

Clause 9: The apparatus of clause 8, wherein the UE is configured to receive mapping of the Tx/Rx beam angles of the one or more static broadcast beams with the corresponding one or more beam ID over Radio Resource Control (RRC) signaling or over System Information Block type1.

Clause 10: The apparatus of clause 9, wherein the apparatus is further configured to: receive the angle granularity information from a base station in a Radio Resource Control (RRC) message.

Clause 11: The apparatus of clause 7, wherein if the apparatus is a base station, the apparatus is configured to: receive at least one of Beam ID from a User Equipment (UE) as beam information and association information as the one or more control parameters, wherein the association information comprises at least one of: total number of antenna panels at the UE, total number of received beams and beams per panel, number of received beams in Azimuth and elevation per panel, Panel used for received beam, Beamwidth of the beams per panel.

Clause 12: The apparatus of clause 11, wherein the apparatus is further configured to: determine a beam ID corresponding to the optimized Tx/Rx beam angle; and transmit at least one of: the optimized Tx/Rx beam angle and the beam ID to the UE for beamforming of one or more dynamic beams.

Clause 13: A non-transitory computer-readable storage medium, the computer-readable storage medium including instructions that when executed by a computer, cause the computer to: receive at least one of beam information and one or more control parameters, wherein the beam information comprises Tx/Rx beam angles of one or more static broadcast beams; and predict, using a pre-trained learning model, an optimized Tx/Rx beam angle for one or more dynamic beams corresponding to the one or more static broadcast beams, based on the received at least one of beam information, the one or more control parameters and an angle granularity information for effective communication, wherein the angle granularity information defines variation in beam angle for predicting the optimized Tx/Rx beam angle.

Clause 14: The non-transitory computer-readable storage medium of clause 13, wherein the instructions when executed at UE, the instructions cause the computer to: receive at least one of mapping of the Tx/Rx beam angles of the static broadcast beams with corresponding one or more beam IDs, the granularity information, and a reference signal as the beam information, wherein the received reference signal is used for predicting Reference signal received power (RSRP) for the UE; and provide current location of the UE in a cell and the predicted RSRP as the one or more control parameters.

Clause 15: The non-transitory computer-readable storage medium of clause 14, wherein the instructions when executed cause the computer to receive mapping of the Tx/Rx beam angles of the one or more static beams with the corresponding one or more beam ID over Radio Resource Control (RRC) signaling or over System Information Block type1.

Clause 16: The non-transitory computer-readable storage medium of clause 14, wherein the instructions when executed, cause the computer to receive the angle granularity information from a base station in a Radio Resource Control (RRC) message.

Clause 17: The non-transitory computer-readable storage medium of clause 13, wherein the instructions when executed at base station, the instructions cause the computer to: receive at least one of Beam ID from the UE as beam information and association information as the one or more parameters, wherein the association information comprises at least one of: total number of antenna panels at the UE, total number of received beams and beams per panel, number of received beams in Azimuth and elevation per panel, Panel used for received beam, Beamwidth of the beams per panel.

Clause 18: The non-transitory computer-readable storage medium of clause 17, wherein the instructions when executed, the instruction further cause the computer to: determine a beam ID corresponding to the optimized Tx/Rx beam angle; and transmit at least one of: the optimized Tx/Rx beam angle and the beam ID to the UE for beamforming of one or more dynamic beams.

I/We claim:

1. A method comprising:
receiving, at a receiving entity, at least one of beam information and one or more control parameters, wherein the beam information comprises Tx/Rx beam angles of one or more static broadcast beams; and
predicting, using a pre-trained learning model, an optimized Tx/Rx beam angle for one or more dynamic beams corresponding to the one or more static beams, based on the received at least one of beam information, the one or more control parameters and an angle granularity information for effective communication, wherein the angle granularity information defines variation in beam angle for predicting the optimized beam angle.

2. The method of claim 1, wherein if the pre-trained learning model for predicting the optimized Tx/Rx beam angle for the dynamic beams is deployed at a User Equipment (UE), the method further comprises:
receiving, from a Base station, at least one of mapping of the Tx/Rx beam angles of the static broadcast beams with corresponding one or more beam IDs, the angle granularity information, and a reference signal as the beam information, wherein the received reference signal is used for predicting Reference signal received power (RSRP) for the UE; and
providing, to the pre-trained learning model, current location of the UE in a cell and predicted RSRP as the one or more control parameters.

3. The method of claim 2, wherein the mapping of the Tx/Rx beam angles of the one or more static beams with the corresponding one or more beam ID is received over Radio Resource Control (RRC) signaling or over System Information Block type1.

4. The method of claim 2, wherein the pre-trained learning model initially receives the angle granularity information from the base station in a Radio Resource Control (RRC) message.

5. The method of claim 1, wherein if the pre-trained learning model for predicting the optimized Tx/Rx beam angle for the dynamic beams is deployed at the base station, the method further comprises:
receiving, from a UE, at least one of Beam ID as beam information and association information as the one or more control parameters, wherein the association information comprises at least one of total number of antenna panels at the UE, total number of received beams and beams per panel, number of received beams in Azimuth and elevation per panel, Panel used for received beam, Beamwidth of the beams per panel.

6. The method of claim 5, wherein if the pre-trained learning model for predicting the optimized Tx/Rx beam angle for the dynamic beams is deployed at the base station, the method further comprises:
determining a beam ID corresponding to the optimized Tx/Rx beam angle; and
transmitting, from the base station, at least one of the optimized Tx/Rx beam angle and the beam ID to the UE for beamforming of one or more dynamic beams.

7. An apparatus configured to:
receive at least one of beam information and one or more control parameters, wherein the beam information comprises Tx/Rx beam angles of one or more static broadcast beams; and
predict, using a pre-trained learning model, an optimized Tx/Rx beam angle for one or more dynamic beams corresponding to the one or more static beams, based on the received at least one of beam information, the one or more control parameters and an angle granularity information for effective communication, wherein the angle granularity information defines variation in beam angle for predicting the optimized beam angle.

8. The apparatus of claim 7, wherein if the apparatus is a User Equipment (UE), the apparatus is configured to:
receive at least one of mapping of the Tx/Rx beam angles of the static broadcast beams with corresponding one or more beam IDs, the angle granularity information, and a reference signal as the beam information, wherein the received reference signal is used for predicting Reference signal received power (RSRP) for the UE; and
provide current location of the UE in a cell and the predicted RSRP as the one or more control parameters.

9. The apparatus of claim 8, wherein the UE is configured to receive mapping of the Tx/Rx beam angles of the one or more static beams with the corresponding one or more beam ID over Radio Resource Control (RRC) signaling or over System Information Block type1.

10. The apparatus of claim 9, wherein the apparatus is further configured to:
receive the angle granularity information from a base station in a Radio Resource Control (RRC) message.

11. The apparatus of claim 7, wherein if the apparatus is a base station, the apparatus is configured to:
receive at least one of Beam ID from a User Equipment (UE) as beam information and association information as the one or more control parameters, wherein the association information comprises at least one of: total number of antenna panels at the UE, total number of received beams and beams per panel, number of received beams in Azimuth and elevation per panel, Panel used for received beam, Beamwidth of the beams per panel.

12. The apparatus of claim 11, wherein the apparatus is further configured to:
determine a beam ID corresponding to the optimized Tx/Rx beam angle; and
transmit at least one of: the optimized Tx/Rx beam angle and the beam ID to the UE for beamforming of one or more dynamic beams.

13. A non-transitory computer-readable storage medium, the computer-readable storage medium including instructions that when executed by a computer, cause the computer to:
receive at least one of beam information and one or more control parameters, wherein the beam information comprises Tx/Rx beam angles of one or more static broadcast beams; and
predict, using a pre-trained learning model, an optimized Tx/Rx beam angle for one or more dynamic beams corresponding to the one or more static beams, based on the received at least one of beam information, the one or more control parameters and an angle granularity information for effective communication, wherein the angle granularity information defines variation in beam angle for predicting the optimized beam angle.

14. The non-transitory computer-readable storage medium of claim 13, wherein the instructions when executed at UE, the instructions cause the computer to:
receive at least one of mapping of the Tx/Rx beam angles of the static broadcast beams with corresponding one or more beam IDs, the angle granularity information, and a reference signal as the beam information, wherein the received reference signal is used for predicting Reference signal received power (RSRP) for the UE; and
provide current location of the UE in a cell and the predicted RSRP as the one or more control parameters.

15. The non-transitory computer-readable storage medium of claim 14, wherein the instructions when executed cause the computer to receive mapping of the Tx/Rx beam angles of the one or more static beams with the corresponding one or more beam ID over Radio Resource Control (RRC) signaling or over System Information Block type1.

16. The non-transitory computer-readable storage medium of claim 14, wherein the instructions when executed, cause the computer to receive the angle granularity information from a base station in a Radio Resource Control (RRC) message.

17. The non-transitory computer-readable storage medium of claim 13, wherein the instructions when executed at base station, the instructions cause the computer to:
receive at least one of Beam ID from the UE as beam information and association information as the one or more parameters, wherein the association information comprises at least one of total number of antenna panels at the UE, total number of received beams and beams per panel, number of received beams in Azimuth and elevation per panel, Panel used for received beam, Beamwidth of the beams per panel.

18. The non-transitory computer-readable storage medium of claim 17, wherein the instructions when executed, the instruction further cause the computer to:
determine a beam ID corresponding to the Tx/Rx optimized beam angle; and
transmit at least one of: the optimized Tx/Rx beam angle and the beam ID to the UE for beamforming of one or more dynamic beams.
